(19) United States
(12) Patent Application Publication
(10) Pub. No.: US 2013/0026315 A1
(43) Pub. Date: Jan. 31, 2013

(54) Tripod Leg Adjustment Device

(71) Applicant: Li-Hwa Lee, Foshan (CN)

(72) Inventor: Li-Hwa Lee, Foshan (CN)

(73) Assignee: Foshan Nanhai Chevan Optical Electronics Co., Ltd., Foshan (CN)

(21) Appl. No.: 13/245,071

(22) Filed: Sep. 26, 2011

(30) Foreign Application Priority Data
Jul. 27, 2011 (CN) 201120268525.5

(51) Int. Cl. F16M 11/38

(52) U.S. Cl. 248/168

(57) ABSTRACT

A tripod leg adjustment device including a protection cap having a body that is provided with three axially through slots spaced equally around the one circumference of the body, and three pairs of supporting slab with each pair of supporting slabs disposed abut each slot; a rotary disk that is pivotally mounted on the protection cap by an axially mounting means, the rotary disk having three protrusions extends through the three slots with each of the protrusion provided at its free end an inwardly inclined slope; leg sleeves, with each of the leg sleeve pivotally mounting on a pair of supporting slabs, wherein one end of the leg sleeve provided with a rounded portion and with at least two laterally disposed guiding slope portions in different inclining angles that are complementary to the inwardly inclined slope on the protrusion.

### CROSS-REFERENCE TO RELATED APPLICATIONS

This application claims the benefit of CN Utility Model Application No. 201120268525.5, filed 27 Jul. 2011, the entire contents and substance of which are hereby incorporated by reference.

### BACKGROUND OF THE INVENTION

1. Field of the Invention

The invention relates to a part of a tripod, and more particularly relates to a tripod leg adjustment device.

2. Description of Related Art

A tripod is of tremendous uses in specific area for particular users, e.g. as a camera stabilization device for photographers, or as a measurement tool support for engineers. In the on shelf tripods, the open angle of the tripod legs is adjusted by separate adjustment mechanism. When it is required that the three legs are opened to a same angle, three adjustment mechanisms have to be operated sequentially and repeatedly, which causes inconvenience to the user of the tripod.

### BRIEF SUMMARY OF THE INVENTION

One aspect of the invention is aimed at solving the problems associated with conventional tripods adjustment devices by providing a simple and low cost tripod leg adjustment device having a rotary disk and protection cap assembly that constrain the three legs to a predetermined open angle at the same time.

In one aspect of the present invention, a tripod leg adjustment device comprises a protection cap having a body with three axially through slots spaced equally around one circumference of the body, and three pairs of supporting slabs with each pair of supporting slabs attached to the body and disposed about each slot; a rotary disk pivotally mounted on the protection cap by axially mounting means, the rotary disk having three protrusions extending through the three axially through slots with each of the protrusions provided at its free end an inwardly inclined slope; and leg sleeves, with each of the leg sleeves pivotally mounted on a respective pair of supporting slabs, wherein one end of the leg sleeve is provided with a rounded portion and with at least two laterally disposed guiding slope portions in different inclining angles that are complementary to the inwardly inclined slope on the protrusions.

Preferably, one end of the sleeve is provided thereon with three guiding slope portions having different inclining angles.

Preferably, the rotary disk and the protection cap are brought together with a screw and a nut.

Preferably, the protection cap is provided with at least one blind hole into which a ball and a spring are inserted and are pre-pressed so that an upward restoration force is presented on the ball, the rotary disk provided with grooves complementary to the ball.

Preferably, the leg sleeve is a leg sleeve with a leg.

During operation of the adjustment device, the rotary disk is preset to a first position, for example, the position correspond to a 45 degree open angle, then the leg sleeves are extracted so that the guiding slope portions thereon are in contact with the slopes on the protrusions; as the leg sleeves cannot be move further outwards, the leg sleeves are locked at one direction; if the open angle of the leg sleeves are to be adjusted, the rotary disk is turned relative to the protection cap such that the position of the protrusion in the slot is changed to corresponding to another guiding slope portion on the end of the leg sleeve; the leg sleeves can then be retracted or extracted to another open angle corresponding to this position. The ball and groove arrangement here acts as a position and lateral locking mechanism for the adjustment device, i.e. the ball initially engages with the first groove, with the rotary disk is turned, the ball engages to another groove and the lateral position of the rotary disk relative to the protection cap is retained.

The invention is advantageous in that, the leg sleeves of the device can be open up at the same time to one of the predetermined angles and therefore can ease the open angle adjustment procedure.

These and other objects, features and advantages of the present invention will become more apparent upon reading the following specification in conjunction with the accompanying drawing figures.

### BRIEF DESCRIPTION OF THE DRAWINGS

Various features and advantages of the present invention may be more readily understood with reference to the following detailed description taken in conjunction with the accompanying drawings, wherein like reference numerals designate like structural elements, and in which:

FIG. 1 is a perspective view of the device according to an exemplary embodiment of the invention;

FIG. 2 is a sectional view of the device according to an exemplary embodiment of the invention;

FIG. 3 is an exploded view of the device according to an exemplary embodiment of the invention.

### DETAILED DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

The invention will be described further in detail with reference to the drawings accompanied.

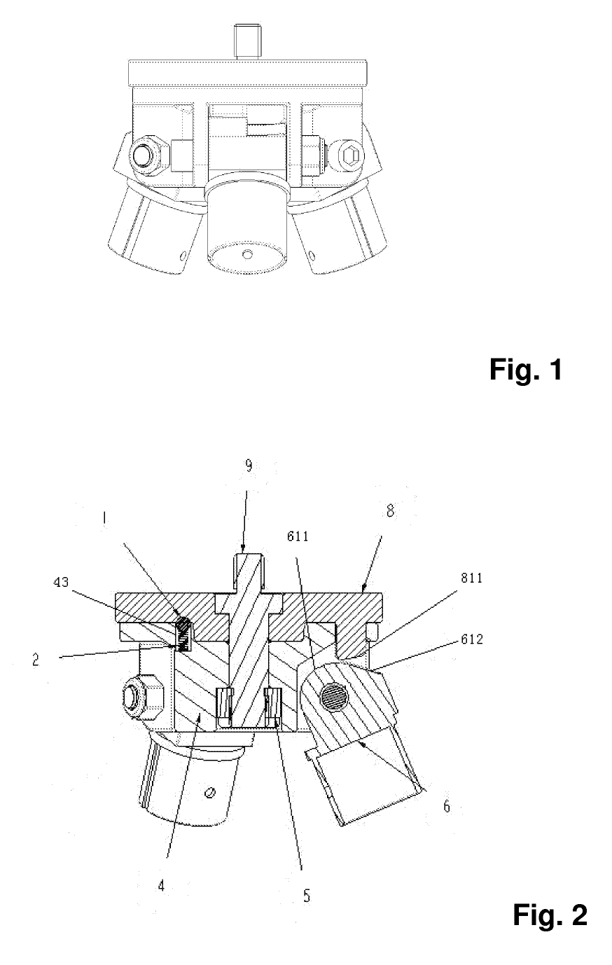

FIGS. 1 to 3 illustrate a tripod leg adjustment device according to one embodiment of the invention. According to FIGS. 1 to 3, the tripod leg adjustment device mainly comprising a rotary disk 8, a protection cap 4, and three leg sleeves 6. On the protection cap 4, three arced slots 41 spaced equally around one circumference of the disk are provided. Preferably, the arced slots are disposed at the circumference of a diameter that is sufficiently less than the diameter of the protection cap 4 so that the strength of the protection cap 4 is maintained. The rotary disk 8 is provided with three protrusions 81 that are also equally spaced at a diameter that is corresponding to the slots on the protection cap 4.

Each of the protrusions 81 having a contour that is adaptive to the shape of the arced slot and is of a lateral dimension that is at least less than half of the length of the slot such that the protraction fills at least no more than half of the slot at a first position, and fills no more than the other half of the slot at a second position. The longitudinal dimension of the protrusion is longer than of the longitudinal dimension of the slot such that the free end of the protrusion may extend out from the bottom surface (assuming the legs are pointing downwards) of the protection cap 4 when the protection cap 4 and the rotary disk 8 are brought together. The free end of the protrusion is provided with an inwards inclined slope portion 811 for engagement with the leg sleeve.

The protection cap 4 and the rotary disk 8 can be brought together and locked by a screw set, that is, a screw 9 extends through the respective center hole of the rotary disk 8 and the protection cap 4 and engages with a nut 5 fixedly seated in the center hole of the protection cap 4. When the two are brought together, the protrusions extend through the respective slots.

The protection cap 4 is provided with a blind hole 43 into which a ball 1 and a spring 2 are provided and are pre-pressed in the hole so that an upward restoration force is preset on the ball 1. The rotary disk 8 is provided with corresponding grooves, e.g. a first groove and a second groove spaced at a distance corresponding to the length of the slot such that when the ball 1 engages with the first groove, the protrusion reside in the first position in the slot, when the ball 1 engages with the second groove, the protrusion reside in the second position. It shall be understood by the person skilled in the art that more than one blind hole and the ball 1 and spring 2 therein can be disposed, and correspondingly, the protrusion can be no more the ⅓ or ¼ of the dimension of the slot such that it can reside in a first position, a second position, a third position and or a forth position in the slot.

Supporting slab pairs 42 are provided under each slot with the two supporting slabs of each pair disposed on each side of one slot. The two supporting slabs in each pair can be disposed in parallel or in an angle along the sides of the slot. The supporting slabs 42 are provided with through holes for attaching a hinge pin.

The three leg sleeves 6, or leg sleeve with leg in another type of tripod, are attached to the protection cap 4 in the same manner, i.e. the tripod leg sleeves are mounted pivotally on respective supporting slab pair by means of hinge pins 7, e.g. a screw and nut fitting. Only one leg sleeve will be described hereinafter for conciseness.

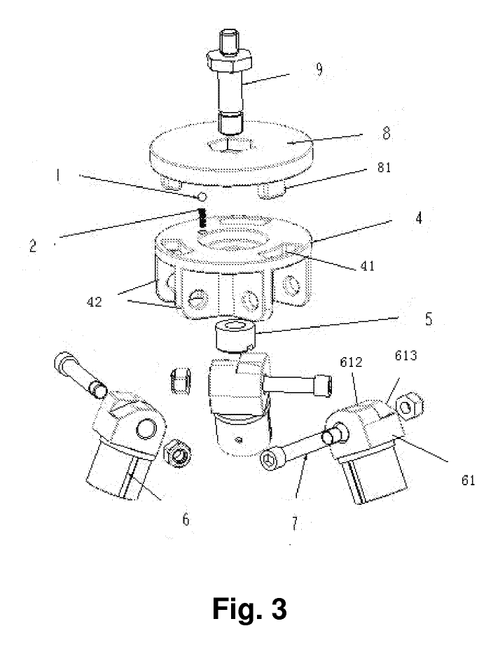

The diameter of the pin hole on the leg can be slightly larger than the diameter of the hinge pin 7 such that a loose fitting is formed and the leg can rotate pivotally around the hinge pin 7. As show in FIGS. 2 and 3, one end 61 of the leg sleeve that is conceived between the slab pair 42 is provided with a rounded portion 611 just like any ordinary tripod leg in the prior art, and with at least two laterally arranged guiding sloped portions 612, 613 in different angles. The number of the guiding slope portion corresponds to the lateral dimension of the protrusion, and consequently corresponds to the number of grooves on the rotary disk 8. In one example, the lateral dimension of the protrusion is less than ½ and more than ⅓ of the dimension of the slot, i.e. the number of grooves on the rotary disk 8 is two, the number of the slope portions shall be two and the angle of the two slopes can be formed in an incremental manner, such as in 30 degrees and 45 degrees. In another example, the lateral dimension of the protrusion is less than ⅓ and more than ¼ of the dimension of the slot, i.e. the number of grooves on the rotary disk 8 is three, the slopes shall be three and the angle of the slopes can be formed in an incremental manner, such as 30 degrees, 45 degrees and 60 degrees.

During operation of the adjustment device, the rotary disk 8 is preset to a first position, for example, the position correspond to 45 degrees, than extract the leg sleeve 6 so that the guiding slope portion 612 thereon corresponding to 45 degrees is in contact with the slope 811 on the protrusion; as the leg sleeves 6 cannot be move further outwards due to the complementary structure of the two i.e. 612 and 811, the leg sleeve 6 is locked by the protrusion at one direction; if the open angle of the leg sleeve 6 is to be adjusted, the rotary disk 8 is turned relative to the protection cap 4 such that the position of the protrusion in the slot is changed to corresponding to another guiding slope portion 613 on the end of the leg sleeve; the leg sleeves 6 can then be retracted or extracted to another open angle corresponding to this position. The ball 1 and groove arrangement act here as a position and lateral locking mechanism for the adjustment device, i.e. the ball 1 is initially in a first groove, with the rotary disk 8 is turned, the ball 1 engages with another groove and the lateral position of the rotary disk 8 relative to the protection cap 4 is retained.

When the leg sleeves 6 are to be retracted, a simple retraction is sufficient as there is no locking mechanism on this reverse direction. If it is desirable that three legs mounted on the leg sleeve are to be locked on this direction, another locking position retaining mechanism can be provide which is common for a skilled person in the field of tripod manufacturing.

In the present invention, the rotary disk, the protection cap and the leg sleeves are described as designed for a tripod, however, a skilled person may envisage that the design can be directed to four or five leg supports without substantive effort.

Also, the described schemes are preferred embodiments of the invention and are not describe for limiting the scope of the invention. That is, any changes and modifications made to the invention that is within common general knowledge of skilled person in the art, such as the guiding slope is formed on the protrusion rather than on the leg and the inwards inclined slope is provided on the leg rather than on the protrusion, shall be considered within the meaning of this invention.

What is claimed is:

1. A tripod leg adjustment device comprising:
a protection cap having a body with three axially through slots spaced equally around one circumference of the body, and three pairs of supporting slabs with each pair of supporting slabs attached to the body and disposed about each slot;
a rotary disk pivotally mounted on the protection cap by axially mounting means, the rotary disk having three protrusions extending through the three axially through slots with each of the protrusions provided at its free end an inwardly inclined slope; and
leg sleeves, with each of the leg sleeves pivotally mounted on a respective pair of supporting slabs, wherein one end of the leg sleeve is provided with a rounded portion and with at least two laterally disposed guiding slope portions in different inclining angles that are complementary to the inwardly inclined slope on the protrusions.

2. The device of claim 1, wherein at least one of the leg sleeves is provided with three guiding slope portions having different inclining angles, respectively.

3. The device of claim 1, wherein the rotary disk and the protection cap are brought together by a screw and a nut.

4. The device of claim 1, wherein the protection cap is provided with at least one blind hole into which a ball and a spring is pre-pressed so that an upward restoration force is preset on the ball, and wherein the rotary disk is provided with at least one groove complimentary engageable with the ball.

5. The device of claim 1, wherein each leg sleeve comprises a leg sleeve with a leg.

6. A tripod leg adjustment device comprising:
a protection cap having a body with three axially through slots spaced equally around one circumference of the body, and three pairs of supporting slabs with each pair of supporting slabs attached to the body and disposed about each slot;
a rotary disk pivotally mounted on the protection cap by an axially mounting mechanism, the rotary disk having three protrusions extending through the three axially through slots with each of the protrusions provided at its free end an inwardly inclined slope; and
leg sleeves, with each of the leg sleeves pivotally mounted on a respective pair of supporting slabs, wherein one end of the leg sleeve is provided with a rounded portion and with at least three laterally disposed guiding slope portions, each in different inclining angles that are complementary to the inwardly inclined slope on the protrusions.

7. The device of claim 6, wherein the rotary disk and the protection cap are brought together by a screw and a nut.

8. The device of claim 6, wherein the protection cap is provided with at least one blind hole into which a ball and a spring is pre-pressed so that an upward restoration force is preset on the ball, and wherein the rotary disk is provided with at least one groove complimentary engageable with the ball.

9. The device of claim 6, wherein each leg sleeve comprises a leg sleeve with a leg.

10. A tripod leg adjustment device comprising:
a protection cap having a body with three axially through slots spaced equally around one circumference of the body, and three pairs of supporting slabs with each pair of supporting slabs attached to the body and disposed about each slot;
a rotary disk pivotally mounted on the protection cap by an axially mounting mechanism, the rotary disk having three protrusions extending through the three axially through slots with each of the protrusions provided at its free end an inwardly inclined slope; and
leg sleeves, with each of the leg sleeves pivotally mounted on a respective pair of supporting slabs, wherein one end of the leg sleeve is provided with a rounded portion and with at least two laterally disposed guiding slope portions, each in different inclining angles that are complementary to the inwardly inclined slope on the protrusions;
wherein the protection cap is provided with at least one blind hole into which a ball and a spring is pre-pressed so that an upward restoration force is preset on the ball, and wherein the rotary disk is provided with at least one groove complimentary engageable with the ball.

11. The device of claim 10, wherein at least one of the leg sleeves is provided with three guiding slope portions having different inclining angles, respectively.

12. The device of claim 10, wherein each leg sleeve comprises a leg sleeve with a leg.
